(19) United States
(12) Patent Application Publication
(10) Pub. No.: US 2025/0105547 A1
(43) Pub. Date: Mar. 27, 2025

(54) MODULAR CONNECTOR

(71) Applicant: LEAR CORPORATION, Southfield, MI (US)

(72) Inventor: Xavier Farré Vives, Valls (ES)

(21) Appl. No.: 18/770,023

(22) Filed: Jul. 11, 2024

Related U.S. Application Data
(60) Provisional application No. 63/584,522, filed on Sep. 22, 2023.

(51) Int. Cl. H01R 13/514; H01R 13/04

(52) U.S. Cl. CPC H01R 13/514; H01R 13/04

(57) ABSTRACT

This disclosure relates to a modular connector that can be selectively configured in accordance with a configuration of a given end-use mating interface that the connector is to be joined to. In an example, the connector includes a connector housing that has a group of terminal assembly cavities, and a group of terminal assemblies that are receivable in the terminal assembly cavities of the connector housing in a unique arrangement. The unique arrangement is selectable from a plurality of unique arrangements that correspond to different predetermined configurations of a mate interface.

### BACKGROUND

Automobiles and other vehicles include components with electronic circuitry that requires connection to other electronic circuitry in the electrical system of the vehicle. For example, circuitry that is associated with an adjustable seat may be connected to the vehicle electrical system to receive power, send and receive control signals, and send and receive other operational communications. Electrical connectors are used to connect such circuitry together, as well as permit components to be separately manufactured and then later connected to the vehicle electrical system when the components are installed into the vehicle.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an electrical connector.

FIG. 2 illustrates an expanded view of an electrical connector.

FIG. 3 illustrates an expanded view of a terminal assembly.

FIG. 4 illustrates a terminal assembly after insertion of the terminal pins.

FIG. 5A illustrates a terminal assembly that has an ethernet configuration.

FIG. 5B illustrates a terminal assembly that has up to twelve terminal pins 0.63 mm size.

FIG. 5C illustrates a terminal assembly that has a 3-port 2.8 mm size configuration.

FIG. 5D illustrates a terminal assembly that has a two-port 6.3 mm size configuration.

FIG. 5E illustrates a terminal assembly that has up to six terminal pins 1.2 mm size.

FIG. 5F illustrates a terminal assembly that has a single port of 8 mm terminal size configuration.

FIG. 5G illustrates a terminal assembly that has up to eighteen terminal pins of 0.5 mm size.

FIG. 6 illustrates an example arrangement of terminal pins in terminal slots of a terminal assembly, with several of the slots empty.

FIG. 7 illustrates another example arrangement of terminal pins in terminal slots of a terminal assembly, with several of the slots empty.

FIG. 8 depicts an electrical connector during assembly.

FIG. 9 depicts the electrical connector later on during assembly.

FIG. 10 illustrates the assembled electrical connector.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

This disclosure relates to an electrical connector that has different terminal modules that can be selectively installed into in order to provide a connector configuration that can be varied, depending on what configuration is desired for a given end-use mating interface. As will be appreciated from the description, such selectivity provides a single design that can be adapted and scaled to many different possible configurations of end-use mating interfaces.

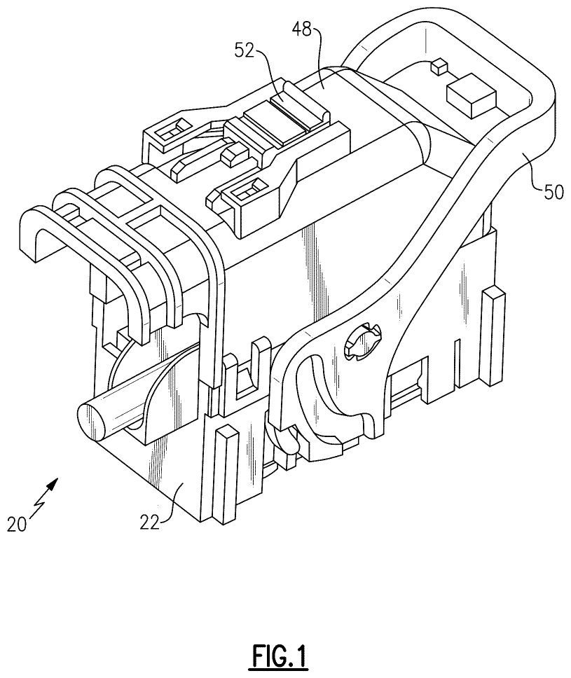

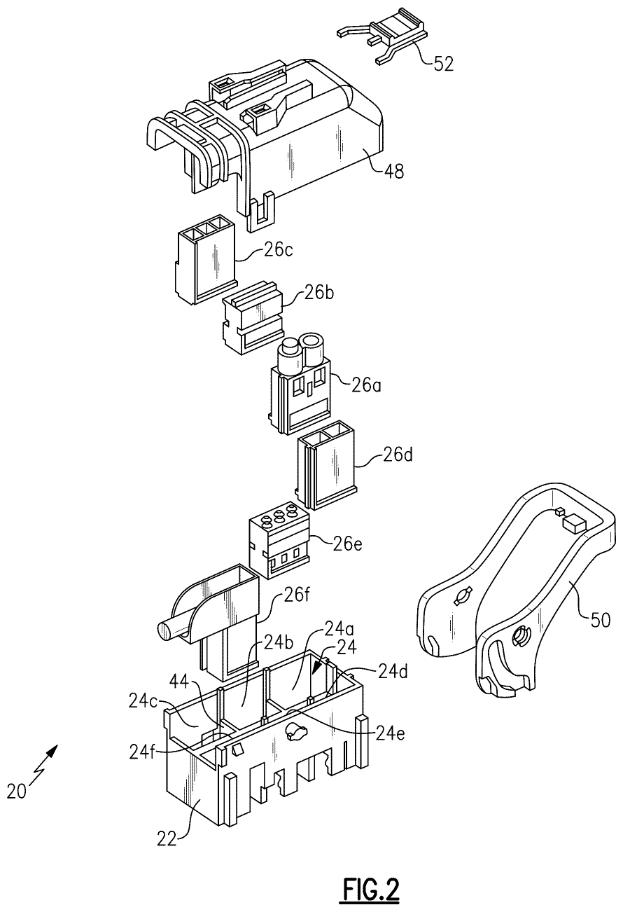

FIG. 1 illustrates an example of an article 20, namely an electrical connector (hereafter “connector 20”), and FIG. 2 illustrates an expanded view of the article 20 so that its sub-components are visible. The connector 20 includes a connector housing 22, as well as a cover 48, a lever 50, and a lock 52 (which will be described in further detail later on below). For example, the connector housing 22 is an enclosing structural element or chassis that is formed from plastic. The connector housing 22 defines a group of terminal assembly cavities 24 (collectively), which are also individually designated as 24a-f. Terminal cavities 24a, 24b, and 24c form a first row of cavities, while terminal cavities 24d, 24c, and 24f form a second row of cavities. Respective pairs of cavities 24a/24d, 24b/24c, and 24c/24f are considered to be columns of cavities such that the terminal assembly cavities 24 in the illustrated example are arranged in a 2×3 configuration of, respectively, the rows (2) and columns (3). Each of the cavities 24 serves as an attachment receptacle to, if selected, receive a terminal assembly 26, which are also individually designated as 26a-f. In the illustrated example, there are six of the cavities 24, and any one of the six of the terminal assemblies 26 can be received into any one of the six cavities 24. It is to be understood, however, that the connector 20 is scalable to have fewer cavities 24 and terminal assemblies 26 (but at least two of each) or additional cavities 24 and terminal assemblies 26, as long as desirable levels for insertion forces are maintained for assembly.

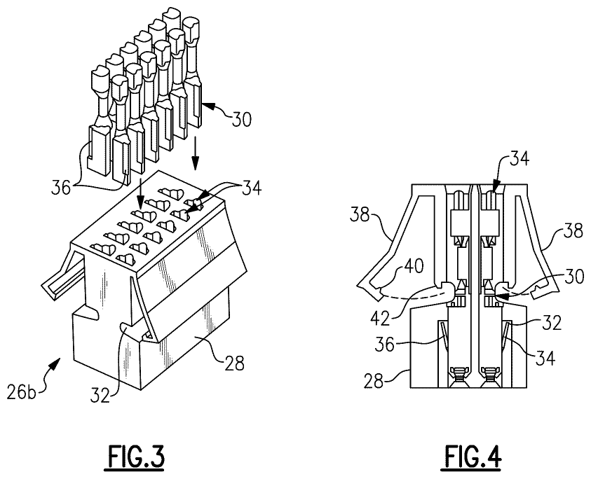

The terminal assembly 26b is shown in an expanded view in FIG. 3 to demonstrate a representative example. Each of terminal assemblies 26 includes a terminal housing 28 and terminal pins 30. The terminal pins 30 form electrical connections to the mating interface into which the terminal pins 30 will be plugged when the connector 20 is joined with the mating interface. The terminal assemblies 26 differ in functionality from each other in that they have different numbers of terminal pins 30 and/or different types of terminal pins 30. The type of terminal pin 30 refers to the kind of interconnection that the terminal is designed for. For instance, non-limiting terminal types include, among other compatible terminals, MQS, MCON, MCP, NanoMQS, and ethernet. The mating interface to which the connector 20 is to be joined includes corresponding terminal plugs to receive the selected terminal types.

In the illustrated example, the terminal housing 28 includes a lock latch surface 32 and terminal slots 34 for receiving the terminal pins 30. The terminal pins 30 each include opposed spring flanges 36 that flare outwardly from the bases of the terminal pins 30. Upon insertion of the terminal pins 30 into the slots 34 of the terminal housing 28, the spring flanges 36 compress against the bases of the terminal pins 30. Upon full insertion as shown in the sectioned view in FIG. 4, the tips of the flanges 36 clear the lock latch surface 32 and the flanges 36 spring outwardly away from the pin bases to engage the lock latch surface 32 and thereby prevent retraction of the terminal pins 30 from the slots 34. The terminal housing 28 additionally includes lock arms 38 that have latches 40. The lock arms 38 are moveable (e.g., manually) to engage the latches 40 over latch flanges 42, preventing the lock arms 38 from disengaging. In this engaged, locked position, the lock arms 38 also engage the terminal pins 30 to thereby prevent retraction of the terminal pins 30 from the slots 34 of the terminal housing 28. It is to be understood that the particular architecture of the terminal assemblies 26, terminal pins 30, and locking mechanisms (with regard to terminal and connector position assurance) may be varied and is not limited to the example shown.

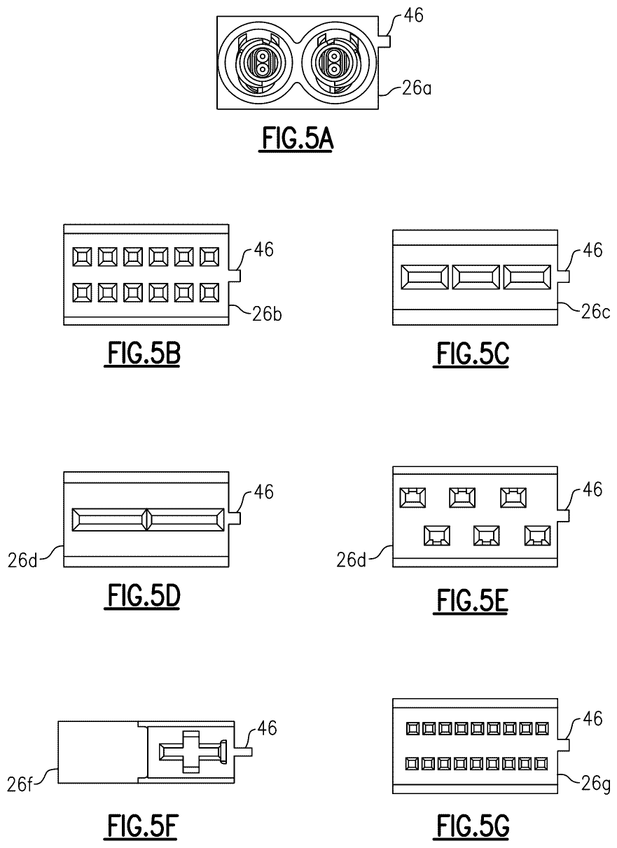

The terminal assemblies 26 are receivable in a unique arrangement into the terminal assembly cavities 24 of the connector housing 22. For example, each one of the terminal assemblies 26 can be installed into any one of the terminal assembly cavities 24. Thus, for each terminal assembly 26, there are six possible cavities 24 into which the assembly 26 can be installed. In this regard, the terminal assembly cavities 24 are of a common cavity geometry, such as but not limited to, a rectangular cavity with a notch projection 44 (FIG. 2). Likewise, the terminal assemblies 26 are of a common terminal assembly geometry that corresponds to the cavity geometry, such as but not limited to, a rectangular shape with a tab projection. FIGS. 5A, 5B, 5C, 5D, 5E, and 5F illustrate, respectively, example terminal assemblies 26a, 26b, 26c, 26d, 26c, and 26f. Terminal assembly 26a is has an ethernet configuration (2-way); terminal assembly 26b has up to twelve terminal pins 30 (12-way, 0.64 mm); terminal assembly 26c has a 3-port configuration (3-way, 2.8 mm); terminal assembly 26d has a two-port configuration (2-way, 6.3 mm); terminal assembly 26c has up to six terminal pins 30 (6-way, 1.2 mm); and terminal assembly 26f has a single port configuration (1-way, 8 mm). FIG. 5G illustrates an additional example of a terminal assembly 26g that has up to eighteen terminal pins 30 (18-way, 0.5 mm). As shown, each terminal assembly 26a, 26b, 26c, 26d, 26c, 26f, and 26f is rectangular in shape and includes a projection 46 on one end. When the terminal assemblies 26 are installed into the terminal cavities 24, the projections 46 arc aligned with, and received into, the notches 44 to ensure that the terminal assemblies 26 are in a proper orientation in the cavities 24.

For example, a unique arrangement of the terminal assemblies 26 in the terminal assembly cavities 24 is an arrangement that is different from all other possible arrangements with respect to the collective locations of the terminal assembly cavities 24 that receive terminal assemblies 26. The unique arrangement is selectable and can thus be chosen from a plurality of possible unique arrangements. For example, there are at least two possible distinct unique arrangements, each corresponding to different predetermined configurations of a mate interface that the connector 20 could be joined to. In further examples to demonstrate non-limiting unique arrangements, a first unique arrangement includes terminal assembly 26b in terminal assembly cavity 24a and terminal assembly 26d in terminal assembly cavity 24c, with the remaining cavities 24b, 24d, 24c, and 24f left empty and the remaining terminal assemblies 26a, 26c, 26e, and 26f being unused. A second unique arrangement includes terminal assembly 26b in terminal assembly cavity 24a, and terminal assembly 26g in terminal assembly cavity 24b, while the remaining terminal cavities 24c, 24, d, 24d, 24c, and 24f are left empty and the remaining terminal assemblies 26a, 26c, 26d, 26c, and 26f being unused. In further examples, each one of the terminal assembly cavities 24 receives one of the terminal assemblies 26a, 26b, 26c, 26d, 26e, or 26f such that there are no empty terminal cavities 24. In in yet further examples, three to five of the terminal assemblies 26 are used and inserted into three to five of the terminal cavities 24.

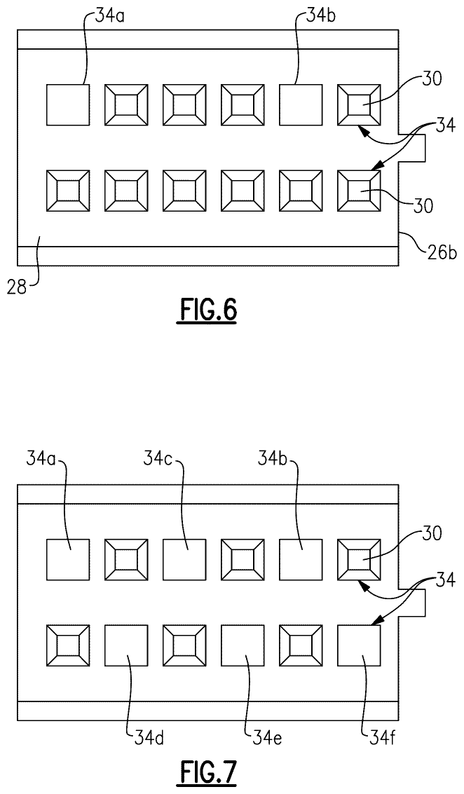

In a further example, the number and locations of the terminal pins 30 in one or more of the terminal assemblies 26 is also selectively variable. For instance, using terminal assembly 26b of FIG. 6 to demonstrate an example, the terminal housing 28 includes a number of terminal slots 34, which in this example is twelve. A number of terminal pins 30 are locked in selected ones of the terminal slots 34, which in this example is ten terminal pins 30. Two of the slots, designated at 34a and 34b, do not contain terminal pins 30 such that the total number of terminal pins 30 in the terminal assembly 26b is less than the total number of available slots 34. The arrangement of the terminal pins 30 in the terminal slots 34 is selectively configurable with respect to whether each of the terminal slots 34 includes one of the terminal pins 30. Thus, the terminal assembly 26b can be selected to have up to twelve terminal pins 30 in any arrangement among the twelve slots 34 in order to match a configuration of terminal plugs in a mating interface. As a comparison, FIG. 7 illustrates another example arrangement of terminal assembly 26b that includes six terminal pins 30 in an alternating arrangement of the slots 34, with slots 34a, 34b, 34c, 34d, 34c, and 34f being empty.

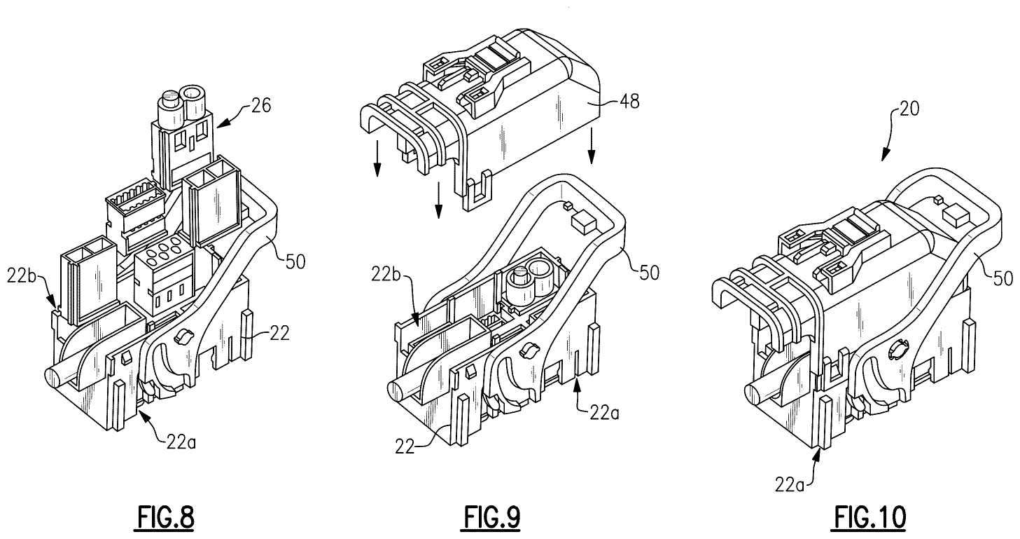

FIGS. 8, 9, and 10 depict a method of assembling the connector 20. Referring to FIG. 8, the connector housing 22 is provided with the lever 50 pre-assembled thereon. For example, the lever 50 is interference-fit into pegs on the connector housing 22 that serve as bearings for later rotation of the lever 50. In accordance with a predetermined configuration of a mate interface to which the connector 20 is to be connected, a unique arrangement is selected for the terminal assemblies 26 in the terminal assembly cavities 24 of the connector housing 22. As shown in FIG. 8, the selected terminal assemblies 26 are then installed into the selected terminal assembly cavities 24 in accordance with the selected unique arrangement. For example, as depicted in FIG. 9, each selected terminal assembly 26 is installed by insertion into a selected one of the terminal assembly cavities 24 and pushed it into the cavity 24 until locked in place, such as with a snap-fit connection. In this regard, the connector housing 22 has a first, mate side 22a that is connectable to the mate interface that the connector 20 is to be joined to, and an opposed second, installation side 22b. The terminal assemblies 26 are receivable through the installation side 22b into the terminal assembly cavities 24.

Once all of the selected terminal assemblies 26 are installed, the cover 48 is then attached onto the connector housing 22 as shown in FIG. 9 to enclose the terminal assembly cavities 24. For example, although not limited, the cover 48 is interference-fit over flanges on the connector housing 22 that interlock with corresponding latches on the cover 48 to provide the assembled connector 20 as depicted in FIG. 10. For connection to the mating interface, the connector 20 is joined to the mating interface such that the terminal pins 30 of the terminal assemblies 26 are received into corresponding terminal plugs in the mating interface. Once joined, the lever 50 is actuated to rotate over the cover 48. The lever 50 includes a cam slot that, upon rotation, interacts with a cam follower on the mating interface and thereby provides a mechanical advantage that facilitates full seating of the connector 20 into the mating interface. The lever 50 is rotated into a fully actuated position past the lock 52, and the lock 52 is then slidingly engaged with the lever 50 to prevent the lever 50 from rotating back and thereby locking the cover 48 on the connector housing 22. As will be appreciated, other types of covers, installation mechanisms, and locks can alternatively be used for enclosing the terminal assemblies 26 and position assurance. In a further example, the method also includes assembling one or more of the selected terminal assemblies 26, including selecting the number and locations of the terminal pins 30 in the terminal slots 34 of the terminal housing 28, as discussed above with respect to FIGS. 6 and 7.

As will be understood from the above description, the connector 20 is configurable to a wide variety of different possible configurations and types of mating interfaces. Thus, a single common connector housing 22 design can be used for connection with several different mating interfaces via selection of the terminal assemblies 26 and locations of the terminal assemblies 26 in the terminal cavities 24 to match that of a given mating interface. Moreover, the design of the connector 20 is scalable to fewer or additional rows and columns of terminal cavities 24 and can thus be adapted to an even wider variety of mating interfaces as may be needed in future design implementations.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. An article comprising:
a connector housing comprising a group of terminal assembly cavities; and
a group of terminal assemblies that differ in functionality from each other, the terminal assemblies of the group receivable in the terminal assembly cavities of the connector housing in a unique arrangement. the unique arrangement selectable from a plurality of unique arrangements corresponding to different predetermined configurations of a mate interface.

2. The article as recited in claim 1, wherein the terminal assembly cavities are of a common cavity geometry and the terminal assemblies are of a common terminal assembly geometry that corresponds to the common cavity geometry.

3. The article as recited in claim 1, wherein at least one of the terminal assemblies has a first number of terminal slots and a second number of terminal pins locked in selected ones of the terminal slots, wherein the second number is less than the first number such that at least one of the terminal slots is empty.

4. The article as recited in claim 1, wherein the at least one of the terminal assemblies includes terminal slots and terminal pins receivable into the terminal slots, and an arrangement of the terminal pins in the terminal slots is selectively configurable with respect to whether each of the terminal slots includes one of the terminal pins.

5. The article as recited in claim 1, wherein a first one of the terminal assemblies has first number of terminals and a second one of the terminal assemblies has a second number of terminals that differs from the first number of terminals.

6. The article as recited in claim 1, wherein at least one of the unique arrangements excludes one or more of the terminal assemblies such that one or more of the terminal assembly cavities is empty.

7. The article as recited in claim 1, wherein a first one of the terminal assemblies has a first type of terminal and a second one of the terminal assemblies has a second type of terminal that differs from the first type of terminal.

8. The article as recited in claim 1, wherein the connector housing has a first, mate side that is connectable to a mate interface, an opposed second, installation side that is attachable with a cover that encloses the terminal assembly cavities, and the terminal assemblies are receivable through the installation side into the terminal assembly cavities.

9. The article as recited in claim 1, wherein the terminal assembly cavities are arranged in rows and columns, including at least a first row, a second row, a first column, and a second column.

10. The article as recited in claim 9, wherein a first one of the unique arrangements includes a first one of the terminal assemblies in one of the terminal assembly cavities of the first row, a second one of the terminal assemblies in one of the terminal assembly cavities of the second row, and the remaining ones of the terminal assembly cavities are empty.

11. The article as recited in claim 10, wherein a second one of the unique arrangements includes two of the terminal assemblies in the terminal assembly cavities of the first row and the remaining ones of the terminal assembly cavities are empty.

12. The article as recited in claim 9, wherein the terminal assembly cavities are arranged in a 2×3 configuration of, respectively, the rows and columns.

13. A method comprising:
in accordance with a predetermined configuration of a mate interface to which a connector is to be connected, selecting a unique arrangement from a plurality of unique arrangements of a group of terminal assemblies in a group of terminal assembly cavities of a connector housing; and
assembling the connector by installing the group of terminal assemblies in the group of terminal assembly cavities in accordance with the selected unique arrangement.

14. The method as recited in claim 13, further comprising attaching a cover onto the connector housing, the cover enclosing the terminal assemblies in the terminal assembly cavities.

15. The method as recited in claim 13, further comprising assembling each of the terminal assemblies, each of the terminal assemblies has a first number of terminal slots, the assembling includes locking a second number of terminals in selected ones of the terminal slots, and in at least one of the terminal assemblies the second number is less than the first number such that at least one of the terminal slots is empty.

16. The method as recited in claim 13, wherein the connector housing has a first, mate side that is connectable to a mate interface and an opposed second, installation side that is attachable with a cover that encloses the terminal assembly cavities, and the assembling includes installing the terminal assemblies through the installation side into the terminal assembly cavities.
